(19) United States
(12) Patent Application Publication
(10) Pub. No.: US 2004/0188897 A1
(43) Pub. Date: Sep. 30, 2004

(54) Compressible fluid strut

(75) Inventors: Jeremy R. Edmondson, Canton, MI (US); Joshua D. Coombs, Whitmore Lake, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/397,883

(22) Filed: Mar. 26, 2003

(51) Int. Cl. F16F 5/00

(52) U.S. Cl. 267/64.13; 267/64.26

(57) ABSTRACT

The suspension strut of an embodiment of the invention includes a compressible fluid, a sleeve structure, a hydraulic tube adapted to contain a portion of the compressible fluid, a displacement rod and cavity piston coupled to the sleeve and adapted to move into the hydraulic tube upon the compression movement of the wheel and to move out of the hydraulic tube upon the rebound movement of the wheel, and a hydraulic seal located between the hydraulic tube and the displacement rod. The hydraulic tube defines a hydraulic cavity adapted to contain a portion of the compressible fluid and to cooperate with the compressible fluid to supply a suspending spring force that biases the wheel toward the surface.

### TECHNICAL FIELD

The subject matter of this invention generally relates to suspension struts for a vehicle and, more particularly, to suspension struts including a compressible fluid.

### BACKGROUND

In the typical vehicle, a combination of a coil spring and a gas strut function to allow compression movement of a wheel toward the vehicle and rebound movement of the wheel toward the ground. The suspension struts attempt to provide isolation of the vehicle from the roughness of the road and resistance to the roll of the vehicle during a turn. More specifically, the typical coil spring provides a suspending spring force that biases the wheel toward the ground and the typical gas strut provides a damping force that dampens both the suspending spring force and any impact force imparted by the road. Inherent in every conventional suspension strut is a compromise between ride (the ability to isolate the vehicle from the road surface) and handling (the ability to resist roll of the vehicle). Vehicles are typically engineered for maximum road isolation (found in the luxury market) or for maximum roll resistance (found in the sport car market). There is a need, however, for an improved suspension strut that avoids this inherent compromise.

### BRIEF DESCRIPTION OF THE DRAWINGS

FIG. 1 is a front view of a suspension strut of the preferred embodiment of the invention, shown within a vehicle.

FIG. 2 is a cross-sectional view of the suspension strut of the first preferred embodiment of the invention.

FIG. 3 is a cross-sectional view of a suspension strut of the second preferred embodiment of the invention.

### DETAILED DESCRIPTION

The following description of the two embodiments of the invention is not intended to limit the invention to these preferred embodiments, but rather to enable any person skilled in the art of suspension struts to use this invention.

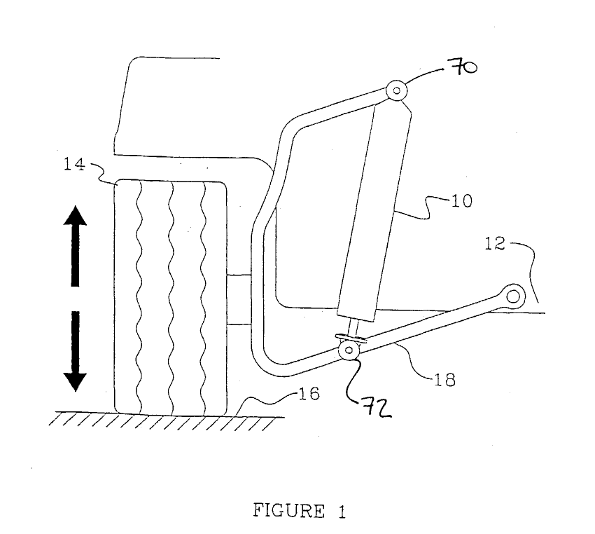

As shown in FIG. 1, the suspension strut 10 of the invention has been specifically designed for a vehicle 12 having a wheel 14 contacting a surface 16 under the vehicle 12 and a suspension link 18 suspending the wheel 14 from the vehicle 12. The suspension link 18 allows compression movement of the wheel 14 toward the vehicle 12 and rebound movement of the wheel 14 toward the surface 16. Despite its design for a particular environment, the suspension strut 10 may be used in any suitable environment.

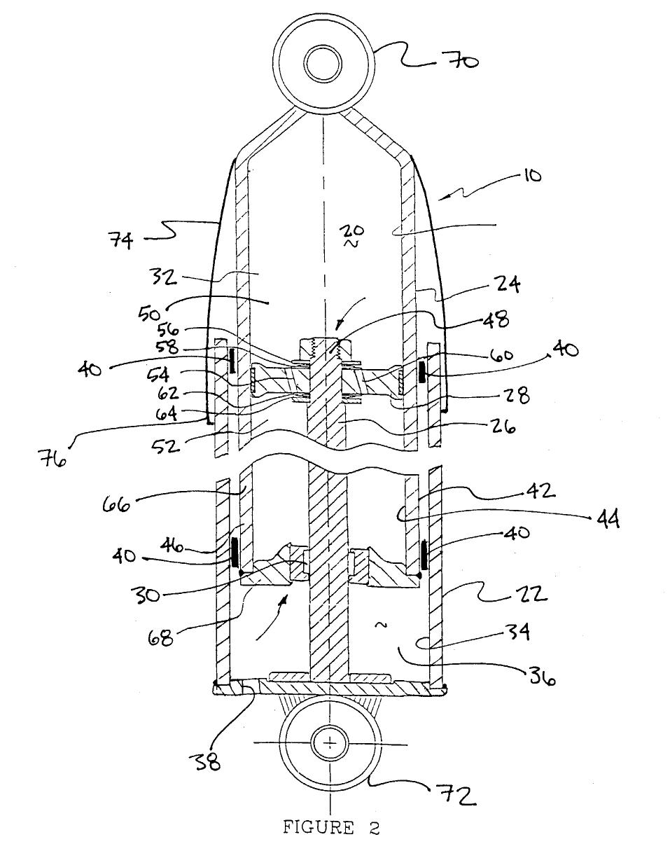

As shown in FIG. 2, the suspension strut 10 of the first preferred embodiment includes a compressible fluid 20, a sleeve structure 22, a hydraulic tube 24 adapted to contain a portion of the compressible fluid 20, a displacement rod 26 and cavity piston 28 coupled to the sleeve and adapted to move into the hydraulic tube 24 upon the compression movement of the wheel and to move out of the hydraulic tube 24 upon the rebound movement of the wheel, and a hydraulic seal 30 located between the hydraulic tube 24 and the displacement rod 26. The hydraulic tube 24 defines a hydraulic cavity 32 adapted to contain a portion of the compressible fluid 20 and to cooperate with the compressible fluid 20 to supply a suspending spring force that biases the wheel toward the surface. The suspension strut 10, of course, may include other components or systems that do not substantially interfere with the functions and purposes of these components.

The compressible fluid 20 of the first preferred embodiment, which cooperates to supply the suspending spring force, is preferably a silicon fluid that compresses about 1.5% volume at 2,000 psi, about 3% volume at 5,000 psi, and about 6% volume at 10,000 psi. Above 2,000 psi, the compressible fluid 20 has a larger compressibility than conventional hydraulic oil. The compressible fluid 20, however, may alternatively be any suitable fluid, with or without a silicon component, that provides a larger compressibility above 2,000 psi than conventional hydraulic oil.

The sleeve structure 22 of the first preferred embodiment, which cooperatives with the hydraulic tube 24 to couple the suspension link and the vehicle, includes an inner sleeve surface 34 that defines a sleeve cavity 36. The sleeve cavity 36 is preferably designed to allow movement of the hydraulic tube 24 into the sleeve cavity 36 during the compression movement of the wheel toward the vehicle and to allow retraction of the hydraulic tube 24 from the sleeve cavity 36 during movement of the wheel toward the surface. In the preferred embodiment, the sleeve structure 22 includes a sleeve orifice 38 adapted to vent fluid to the atmosphere during the compression movement of the wheel and the simultaneous movement of the hydraulic tube 24 into the sleeve cavity 36. In alternative embodiments, the sleeve structure 22 may include other suitable devices to accommodate the reducing volume in the sleeve cavity 36 during the compression movement.

In the first preferred embodiment, the sleeve structure 22 is connectable to the suspension link and the hydraulic tube 24 is connectable to the vehicle. In alternative embodiments, however, the sleeve structure 22 may be connectable to the vehicle, while the hydraulic tube 24 is connectable to the suspension link. Preferably, the sleeve structure 22 and the hydraulic tube 24 further cooperate to substantially accommodate all side loads on the suspension strut 10. To assist with this feature, the suspension strut 10 of the first preferred embodiment includes several bearings 40 located between the inner sleeve surface 34 of the sleeve structure 22 and an outer hydraulic surface 42 of the hydraulic tube 24 and adapted to maintain axial alignment of the sleeve structure 22 and the hydraulic tube 24. The bearings 40 are preferably conventional sleeve bearings, but may alternatively be any other suitable device. By substantially accommodating the side loads on the strut, the displacement rod 26, the cavity piston 28, and the hydraulic seal 30 do not have to be designed to accommodate any side loads. The sleeve structure 22 is preferably made from conventional steel and with conventional methods, but may alternatively be made from any suitable material and with any suitable method.

The hydraulic seal 30 of the first preferred embodiment, which functions to maintain a pressure differential between the hydraulic cavity 32 and the sleeve cavity 36, is preferably located between an inner hydraulic surface 44 of the hydraulic tube 24 and the displacement rod 26. The hydraulic seal 30 preferably includes a single-step TEFLON seal element and a plastic back-up ring, which essentially reinforces the seal element. With this preferred arrangement, as the pressure increases, the back-up ring provides structure to the seal element that resists the increase in seal lip contact force (thereby reducing friction). Furthermore, the back-up ring prevents the seal element from extruding, or creeping over time (thereby improving durability). The hydraulic seal 30 may, however, include other suitable components.

The hydraulic tube 24 preferably includes a distal hydraulic end 46 and the inner hydraulic surface 44, which defines the hydraulic cavity 32 and functions to contain a portion of the compressible fluid 20. As previously mentioned, the hydraulic cavity 32 and the compressible fluid 20 preferably cooperate to supply the suspending spring force that biases the wheel toward the surface, and essentially suspends the entire vehicle above the surface. The distal hydraulic end 46 of the hydraulic tube 24 is adapted to move into the sleeve cavity 36 upon the compression movement of the wheel and to retract from the sleeve cavity 36 upon the rebound movement of the wheel. Similarly (and simultaneously), the distal rod end 48 of the displacement rod 26 is adapted to move into the hydraulic cavity 32 upon the compression movement of the wheel and to retract from the hydraulic cavity 32 upon the rebound movement of the wheel. As it moves further into the hydraulic cavity 32, the displacement rod 26 displaces, and thereby compresses, the compressible fluid 20. In this manner, the movement of the displacement rod 26 into the hydraulic cavity 32 increases the suspending spring force of the suspension strut 10. As the displacement rod 26 moves out of the hydraulic cavity 32, the compressible fluid 20 decompresses and the suspending spring force of the suspension strut 10 decreases. The displacement rod 26 is preferably cylindrically shaped and, because of this preference, the displacement of the displacement rod 26 within the hydraulic cavity 32 and the magnitude of the suspending spring force have a linear relationship. If a linear relationship is not preferred for the particular application of the suspension strut 10, or if there is any other appropriate reason, the displacement rod 26 may be alternatively designed with another suitable shape. The hydraulic tube 24 and the displacement rod 26 are preferably made from conventional steel and with conventional methods, but may alternatively be made from any suitable material and with any suitable method.

The cavity piston 28 of the first preferred embodiment is preferably coupled to the distal rod end 48 of the displacement rod 26 and preferably extends to the inner hydraulic surface 44 of the hydraulic tube 24. In this manner, the cavity piston 28 separates the hydraulic cavity 32 into a first section 50 and a second section 52. The cavity piston 28 defines a first orifice 54, which preferably extends between the first section 50 and the second section 52 of the hydraulic cavity 32. The first orifice 54 functions to allow flow of the compressible fluid 20 between the first section 50 and the second section 52 of the hydraulic cavity 32. The cavity piston 28 is preferably securely mounted to the displacement rod 26 by a conventional fastener, but may alternatively integrally formed with the displacement rod 26 or securely mounted with any suitable device. The cavity piston 28 is preferably made from conventional materials and with conventional methods, but may alternatively be made from other suitable materials and with other suitable methods.

In the first preferred embodiment, the suspension system also includes a first variable restrictor 56 of the first preferred embodiment is coupled to the cavity piston 28 near the first orifice 54. The first variable restrictor 56 functions to restrict the passage of the compressible fluid 20 through the first orifice 54 and, more specifically, functions to variably restrict the passage based on the velocity of the cavity piston 28 relative to the hydraulic tube 24. In the first preferred embodiment, the first variable restrictor 56 is a first shim stack 58 preferably made from conventional materials and with conventional methods. In alternative embodiments, the first variable restrictor 56 may include any other suitable device able to variably restrict the passage of the compressible fluid 20 through the first orifice 54 based on the velocity of the cavity piston 28 relative to the hydraulic tube 24.

In the first preferred embodiment of the invention, the cavity piston 28 also defines a first orifice 60, which—like the first orifice 54—preferably extends between the first section 50 and the second section 52 of the hydraulic cavity 32 and functions to allow flow of the compressible fluid 20 between the first section 50 and the second section 52 of the hydraulic cavity 32. Further, the suspension strut 10 of the first preferred embodiment also includes a second variable restrictor 62 coupled to the cavity piston 28 near the first orifice 60. The second variable restrictor 62—like the first variable restrictor 56—functions to restrict the passage of the compressible fluid 20 through the first orifice 60 and, more specifically, functions to variably restrict the passage based on the velocity of the cavity piston 28 relative to the hydraulic tube 24.

In the preferred embodiment, the second variable restrictor 62 is a second shim stack 64 preferably made from conventional materials and with conventional methods. In alternative embodiments, the second variable restrictor may include any suitable device able to variably restrict a passage of the compressible fluid 20 through the first orifice 60 based on the velocity of the cavity piston 28 relative to the hydraulic tube 24.

The cavity piston 28, the first orifice 54, and the first variable restrictor 56 of the first preferred embodiment cooperate to supply the rebound damping force during the rebound movement of the wheel. The rebound damping force acts to dampen the suspending spring force that tends to push the displacement rod 26 out of the hydraulic tube 24. The cavity piston 28, the first orifice 60, and a second variable restrictor 62, on the other hand, cooperate to supply the compression damping force during the compression movement of the wheel. The compression damping force acts to dampen any impact force that tends to push the displacement rod 26 into the hydraulic tube 24.

The hydraulic tube 24 of the first preferred embodiment includes a first portion 66 and a second portion 68, which aids in the assembly of the suspension strut 10. During the assembly, the second portion 68 of the hydraulic tube 24 is slid over the displacement rod 26 and the cavity piston 28 is mounted to the displacement rod 26, preferably with a fastener. Then, the cavity piston 28 is slid into the first portion 66 of the hydraulic tube 24 and the second portion 68 of the hydraulic tube 24 is fastened to the first portion 66, preferably with a weld.

As shown in FIGS. 1 and 2, the suspension strut 10 of the first preferred embodiment also includes a first connector 70 and a second connector 72. In the preferred embodiment, the connectors 70 and 72 are made from a structural material that firmly mounts the suspension strut 10 to the vehicle 12 without any substantial compliancy. In this manner, the suspension strut 10 provides all of the isolation between the vehicle 12 and the suspension link 18. In alternative embodiments, either the first connector 70, the second connector 72, or both connectors 70 and 72 may include elastic material that connects the suspension strut 10 to the vehicle 12 with some compliancy. In this manner, the suspension strut 10 and the connectors 70 and 72 act in a series to provide the isolation between the vehicle 12 and the suspension link 18. The connectors 70 and 72 are preferably made with conventional materials and from conventional methods, but may alternatively be made with any suitable material and from any suitable method.

As shown in FIG. 2, the suspension strut 10 of the first preferred embodiment also includes a dust boot 74 connected to the hydraulic tube 24. The dust boot 74 preferably includes a distal dust end 76 adapted to move over the sleeve structure 22 upon the compression movement of the wheel. The dust boot 74 functions to substantial prevent dust and debris from entering the sleeve cavity 36 and from contaminating the bearings 40.

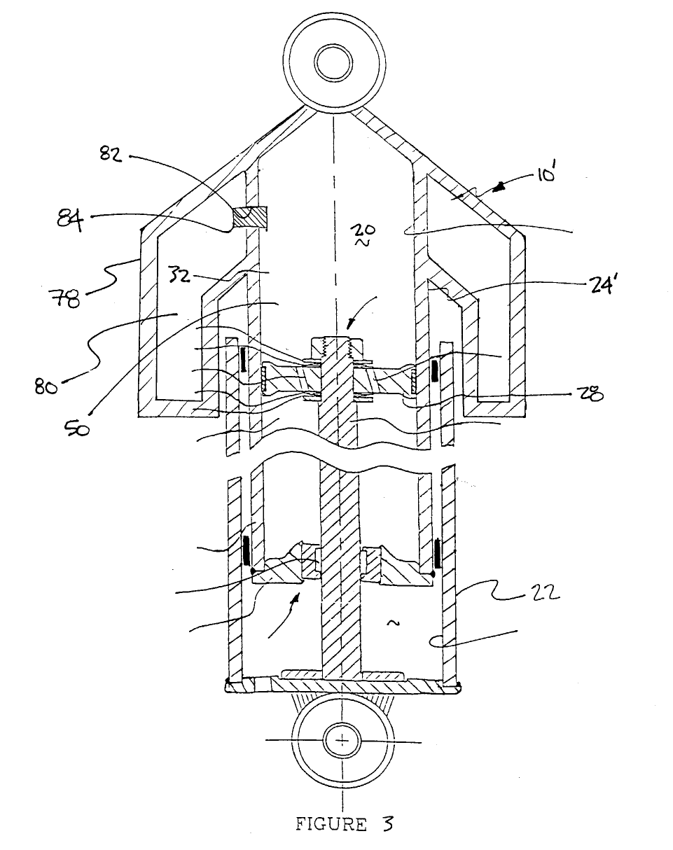

As shown in FIG. 3, in addition to the components of the suspension strut 10 of the first preferred embodiment, the suspension strut 10′ of the second preferred embodiment includes a pressure vessel 78. The pressure vessel 78 cooperates with a modified hydraulic tube 24′ to define an outer cavity 80. The hydraulic tube 24′ defines a tube opening 82, which functions to fluidly connect the first section 50 of the hydraulic cavity 32 and the outer cavity 80. Effectively, the presence of the tube opening 82 within the hydraulic tube 24′ and the pressure vessel 78 around the hydraulic tube 24′ greatly expands the volume of compressible fluid 20 on the “compression side” of the cavity piston 28. In this manner, the size of the hydraulic tube 24′ and the size of the pressure vessel 78 may be adjusted to optimize the suspending spring force of the suspension strut 10′. The pressure vessel may be designed to be located in the typical space of a conventional McPherson strut, or may be designed to be located in any other suitable area of the vehicle.

The suspension strut 10′ of the second preferred embodiment also includes a controllable valve 84 near the tube opening 82 of the hydraulic tube 24′. The controllable valve 84 functions to selectively restrict passage of the compressible fluid 20 between the first section 50 of the hydraulic cavity 32 and the outer cavity 80. The presence or absence of the connection between the first section 50 of the hydraulic cavity 32 and the outer cavity 80 dramatically affects the suspending spring force of the suspension strut 10′.

The suspension strut 10′ of the second preferred embodiment also preferably includes an electric control unit (not shown) coupled to the controllable valve 84. The electric control unit functions to selectively activate the controllable valve 84. Because selective activation of the controllable valve 84 dramatically affects volume of the compressible fluid 20 on the “compression side” of the cavity piston 28, the electric control unit can actively modulate the suspending spring force, the rebound damping force, and/or the compression damping force to achieve the desired ride and handling for the vehicle. For example, as the vehicle encounters a harsh impact force, or a fast turn, the electric control unit may close the controllable valve 84 thereby decreasing the volume of the compressible fluid 20 on the “compression side” of the cavity piston 28. This response may achieve the desired ride and handling for the vehicle. Both the controllable valve 84 and the electric control unit are preferably conventional devices, but may alternatively be any suitable device to selectively restrict the passage of compressible fluid 20.

In all other aspects, the suspension strut 10′ of the second preferred embodiment is similar to the suspension strut 10 of the first preferred embodiment.

As any person skilled in the art of suspension struts will recognize from the previous description and from the figures and claims, modifications and changes can be made to the preferred embodiments of the invention without departing from the scope of this invention defined in the following claims.

We claim:

1. A suspension strut for a vehicle having a wheel contacting a surface under the vehicle and a suspension link suspending the wheel from the vehicle and allowing compression movement of the wheel toward the vehicle and rebound movement of the wheel toward the surface, said suspension strut comprising:
a compressible fluid;
a sleeve structure having an inner sleeve surface defining a sleeve cavity;
a hydraulic tube having a distal hydraulic end adapted to move into said sleeve cavity upon the compression movement of the wheel and an inner hydraulic surface defining a hydraulic cavity adapted to contain a portion of said compressible fluid and to cooperate with said compressible fluid to supply a suspending spring force that biases the wheel toward the surface;
a displacement rod connected to said sleeve and having a distal rod end adapted to move into said hydraulic cavity upon the compression movement of the wheel and to move out of said hydraulic cavity upon the rebound movement of the wheel;
a cavity piston coupled to said distal rod end of said displacement rod and extending to said inner hydraulic surface thereby separating said hydraulic cavity into a first section and a second section, said cavity piston defining a piston orifice adapted to allow flow of said compressible fluid between said first section and said second section of said hydraulic cavity; and
a hydraulic seal located between said inner hydraulic surface and said displacement rod and adapted to maintain a pressure differential between said hydraulic cavity and said sleeve cavity;
wherein one of said sleeve structure and said hydraulic tube is connectable to the vehicle and the other is connectable to the suspension link.

2. The suspension strut of claim 1 wherein said sleeve structure includes a sleeve orifice adapted to vent fluid to the atmosphere.

3. The suspension strut of claim 1 further comprising bearings located between said inner sleeve surface and said outer hydraulic surface and adapted to maintain axial alignment of said sleeve structure and said hydraulic tube.

4. The suspension strut of claim 1 wherein said compressible fluid includes a silicone fluid.

5. The suspension strut of claim 1 wherein said compressible fluid has a larger compressibility above 2,000 psi than hydraulic oil.

6. The suspension strut of claim 1 wherein said compressible fluid is adapted to compress about 1.5% volume at 2,000 psi, about 3% volume at 5,000 psi, and about 6% volume at 10,000 psi.

7. The suspension strut of claim 1 further comprising a first variable restrictor coupled to said cavity piston and adapted to variably restrict the passage of said compressible fluid through said first orifice based on the velocity of said cavity piston relative to said hydraulic tube; wherein said cavity piston, said first orifice, and said first variable restrictor cooperate to supply a rebound damping force during the rebound movement of the wheel.

8. The suspension strut of claim 1 wherein said cavity piston defines a second orifice adapted to allow passage of said compressible fluid between said first section and said second section of said hydraulic cavity.

9. The suspension strut of claim 8 further comprising a second variable restrictor coupled to said cavity piston and adapted to variably restrict the passage of said compressible fluid through said second orifice based on the velocity of said cavity piston relative to said hydraulic tube; wherein said cavity piston, said second orifice, and said second variable restrictor cooperate to supply a compression damping force during the compression movement of the wheel.

10. The suspension strut of claim 1 wherein said sleeve structure is connectable to said suspension link and said hydraulic tube is connectable to said vehicle.

11. The suspension strut of claim 1 further comprising a dust boot connected to said hydraulic tube and having a distal dust end adapted to move over said sleeve structure upon the compression movement of the wheel.

12. The suspension strut of claim 1 further comprising a pressure vessel defining an outer cavity and adapted to contain a portion of said compressible fluid; wherein said hydraulic tube defines a tube opening adapted to fluidly connect said first section of said hydraulic cavity and said outer cavity; and wherein said pressure vessel and said tube opening cooperate with said hydraulic tube and said compressible fluid to supply the suspending spring force.

13. The suspension strut of claim 12 further comprising a controllable valve adapted to selectively restrict passage of said compressible fluid between said first section of said hydraulic cavity and said outer cavity.

14. The suspension strut of claim 13 further comprising an electric control unit adapted to actively modulate the suspending spring force by selectively actuating said controllable valve.

15. The suspension strut of claim 14 wherein said electric control unit is further adapted to actively modulate the rebound damping force by selectively actuating said controllable valve.

16. The suspension strut of claim 14 wherein said electric control unit is further adapted to actively modulate the compression damping force by selectively actuating said controllable valve.
